(19) United States
(12) Patent Application Publication
(10) Pub. No.: US 2026/0126538 A1
(43) Pub. Date: May 7, 2026

(54) SYSTEM FOR VIEW DEPENDENT SONAR SURVEY DATA PROCESSING, AND METHOD FOR SAME

(71) Applicant: Terradepth, Inc., Austin, TX (US)

(72) Inventors: Andrew RESNICK, Austin, TX (US); Kris RYDBERG, Austin, TX (US); Josef WOLFEL, Austin, TX (US); Qasim IQBAL, Austin, TX (US)

(73) Assignee: Terradepth, Inc., Austin, TX (US)

(21) Appl. No.: 19/115,692

(22) PCT Filed: Sep. 26, 2023
(86) PCT No.: PCT/US2023/033731

§ 371 Date: Mar. 26, 2025

Related U.S. Application Data
(60) Provisional application No. 63/409,961, filed on Sep. 26, 2022.

(51) Int. Cl. G01S 7/52; G01S 7/53; G01S 15/89

(52) U.S. Cl. CPC G01S 7/52053; G01S 7/53; G01S 15/8902

(57) ABSTRACT

The Sonar Multiview Engine is a system for sonar data processing to enhance analysis and display of the sonar data. The Sonar Multiview Engine may include a use of sonar data from multiple sensors and three subsystems: a multiview processing and storage system, a Multiview Analysis Subsystem, and a multiview display system. The Sonar Multiview Engine uses data processed by sonar instruments and navigation instruments as input. The Sonar Multiview Engine may be used to produce geophysical and hydrographic seafloor maps, seafloor acoustic reflectance models, seafloor terrain models, and other representations and analyses for interpretation or understanding of the seafloor. The Sonar Multiview Engine may be applied to either new sonar data or existing sonar data that may be stored or streamed directly to the engine.

### INTRODUCTION

This disclosure relates to sonar data processing of: geophysical and hydrographic seafloor surveys, seafloor acoustic reflectance models, and seafloor terrain models (collectively “seafloor data”) of bodies of water such as the oceans and freshwater bodies such as lakes and rivers (collectively, hereinafter “ocean”). More particularly, the disclosure relates to systems and methods for performing view dependent analysis of seafloor data, such as making 3D representations of the seafloor.

Data for analysis of the seafloor may be collected by many kinds of platforms and many kinds of sonars. Examples of platforms include ships, towed bodies, remotely operated vehicles (ROV), and autonomous underwater vehicles (AUV). Examples of sonars include side scan sonar (SSS), multi beam echo sounders (MBES), synthetic aperture sonars (SAS), interferometric sonars, single beam echo sounders (SBES), forward looking sonars (FLS), scanning sonars, and imaging sonars. Sonar data is commonly collected by platforms following planned tracks above the seafloor so that the sonars take data from each area of the seafloor multiple times, from different positions. As the platform follows a track the sonar periodically pings and measures the amplitude of the sonar's backscatter.

The backscatter data may be processed to correct the data for physical distortions caused by the environment and survey equipment, for example time varying gain correcting for reflected amplitude decreasing due to angle of incidence on the seafloor, correction for propagation distance through the water, correction for the properties of the transducers, and georeferencing. The corrections are currently done starting with each survey track individually. The backscatter data collected from sonars on platforms is commonly filtered to reduce data storage requirements. Filtering may be done every ping and/or combining multiple pings to organize the data into a grid using processes such as: averaging a number of measurements to a single value, only passing high signal to noise measurements, passing every n-th measurement, or other processes.

Inputs to seafloor data include navigation data of the platform and sonar including: position, attitude, velocity, and rotation rates. Navigation data may be measured by instruments onboard the platform or offboard the platform. Navigation instruments may include singly or in combination: compass, inertial motion unit (IMU), global positioning systems (GPS), underwater acoustic navigation system, doppler velocity logger (DVL), synthetic aperture sonar (SAS), integrated navigation system (INS), fiber optic gyros (FOG), long baseline acoustic navigation (LBL), ultra-short baseline acoustic navigation (USBL) and other instruments. Additional corrections to navigation may be made when mosaicing multiple tracks by adjusting the tracks images or platform path to match features seen in multiple tracks.

The slope of the seafloor is one of the causes of variation in sonar reflection amplitude. Interpretation of existing seafloor mosaics and models is confusing as for the same spot on the seafloor a sonar amplitude from the east may be strong, white, and from the west weak, black.

Sonar data processing may be performed to make geophysical and hydrographic maps, profiles, three dimensional representations, material listings, and other surveys, maps and geophysical products. For a single view/track data set, two dimensional images or three-dimensional representations may be created directly from the sonar data. Mosaics and other representations of larger areas of seafloor that require combining the sonar backscatter from multiple tracks are created without regard to the angles or vectors from the spot on the seafloor to the sensor.

FIG. 1 shows an area of seafloor with a grid 100 for mosaicing sonar data shown. In a single grid box 101 there are four sonar measurements from sonar platforms 110, 120, 130, and 140 each at an independent position following independent track lines. Existing sonar data processing methods only place each Backscatter Measurement Point in a grid box, but do not compute nor use directional information based on platform position for each sonar measurement. Existing sonar data processing combines sonar backscatter from multiple tracks by arbitrary selection of the track to display, or organizing the data into a grid using an processes to combine multiple pings in a grid box such as: averaging the measurements to a single value or using the strongest amplitude, or for depth using the average depth or the deepest. The images made with existing sonar processing to make mosaics and other representations of multiple tracks mix the measurements from any direction together and process them without distinction for the sonar's angle or vector.

The existing seafloor data processing systems and methods are of limited utility due to the loss of information when producing with only one track at a time, or when combining tracks with processes that reduce the information. The present disclosure provides improved quality of seafloor data for geophysical and/or hydrographic surveying and modeling of the seafloor to be more precise in characterizing the seafloor composition and bathymetry. The present disclosure provides improved systems and methods for seafloor data processing of geophysical and/or hydrographic surveying and modeling of the seafloor, which enable development of more complete, accurate, and reproducible seafloor maps and digital terrain models of the seafloor. The present disclosure provides improved systems and methods for seafloor data processing, which may be efficient in being capable of being performed by machines in an automated manner. The present disclosure provides improved systems and methods for seafloor data processing, which may be efficient in being viewable with common 3D viewer application software. The present disclosure provides improved systems and methods for seafloor data processing, which may enable simplification, flexibility, efficiency, and ease of use, when using a geophysical and/or hydrographic model of the seafloor. The present disclosure provides improved systems and methods for seafloor data processing, which may enable ease of use and visualization for a geophysical and/or hydrographic model of the seafloor having a large size, volume of data, and number of survey points.

Current sonar analysis technology may use optical image-based classification processes that do not account for the difference in sonar measurements vs optical measurements. FIG. 2 illustrates a difference in sonar verse optical images showing a vertical profile normal to the direction of the platform velocity. A platform 201 is carrying a sensor 202 that takes both optical and sonar images for this comparison. The seafloor 210 has an object 211 that protrudes or sticks up from the seafloor. The sensor measures reflected light amplitude for the optical and reflected sound amplitude for the sonar. The sensor 202 builds an optical image 230 based on the angle of returning light along the rays 221, 222, 223, 224, and 225; the rays 222 and 223 demarcate the object 211. The optical image 230 has regions of seafloor 232, object 233, and the edges of the object 234. The sonar image is built from the sonar data 240 based on the elapsed time, which is equated to distance, and illustrated as the arcs 251, 252, 253, 254, and 255. On the sonar image 240 the arcs 252 and 253 demarcate the object-image 242, and arcs 253 and 254 demarcate the image shadow 243 of the object's sonar shadow 212. The farside of the object 212 cannot be seen in either the optical image 230 or the sonar image 240, but in the sonar image the time between the backscatter from ray 222 at arc 252 until ray 225 at arc 254 is shadow. The sonar image of the object 242 compared to the optical image 232 is out of order and the backscatter from the area near the closest top edge doubled as the backscatter from ensonified faces 211 are received at the same time. Comparing the optical image 230 and the sonar image 240 it is clear that interpretation of sonar data requires analysis and processes designed for sonar data and distinct from those used for optical data processing.

### BRIEF DESCRIPTION

The disclosed examples processes sonar data with the direction of each sonar measurements, included in the computations, storage, manual analysis, automated analysis, display, and representations of the sonar data (henceforth the direction of a sonar measurements is called the “Sonar Vector”). In examples where a spot on the seafloor is seen by two or more sonar measurements each with different Sonar Vectors the system's processing that includes the Sonar Vectors of each sonar measurement may enhance the analysis and interpretation of the sonar data.

The Sonar Multiview Engine is a system for sonar data processing to enhance analysis and display of the sonar data. The Sonar Multiview Engine may include a use of sonar data from multiple sensors and three subsystems: a multiview processing and storage system, a Multiview Analysis Subsystem, and a multiview display system. The Sonar Multiview Engine uses data processed by sonar instruments and navigation instruments as input. The Sonar Multiview Engine may be used to produce geophysical and hydrographic seafloor maps, seafloor acoustic reflectance models, seafloor terrain models, and other representations and analyses for interpretation or understanding of the seafloor. The Sonar Multiview Engine may be applied to either new sonar data or existing sonar data that may be stored or streamed directly to the engine.

The disclosed examples may include the multiview processing and storage system that computes each measurement's Sonar Vector, organizes the sonar data to be traceable to the sonar measurement, and stores the sonar data for rapid access by computation, analysis, and display systems. The multiview processing and storage system may use various database and storage technologies.

The disclosed examples may include the Multiview Analysis Subsystem that may use the sonar data stored by the multiview processing and storage system or data from other storage systems as input and perform analysis of the data. The Multiview Analysis Subsystem may include an automated classifier that may use database hashing processes or neural networks that include the Sonar Vector to classify the seafloor based on the sonar data.

The disclosed examples may include the multiview display system that represents the sonar data by computing the best representation for the user's imputed viewing vector based on the Sonar Vectors or the available sonar data. The multiview display system may use rendering, morphing, or interpolation processes for computing the best representation for the viewing vector. The multiview display system may be output on 2D or 3D devices. The multiview display system may change the representation in response to the user's changing the viewing vector in real time.

### DRAWINGS

FIG. 1 Sonar survey from multiple track lines

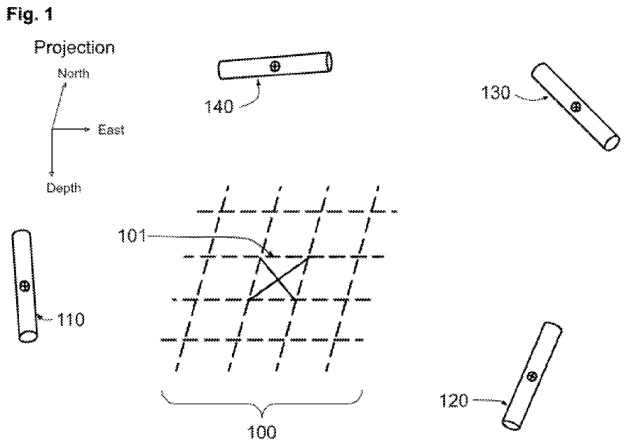

FIG. 2 Sonar vs. optical imaging differences

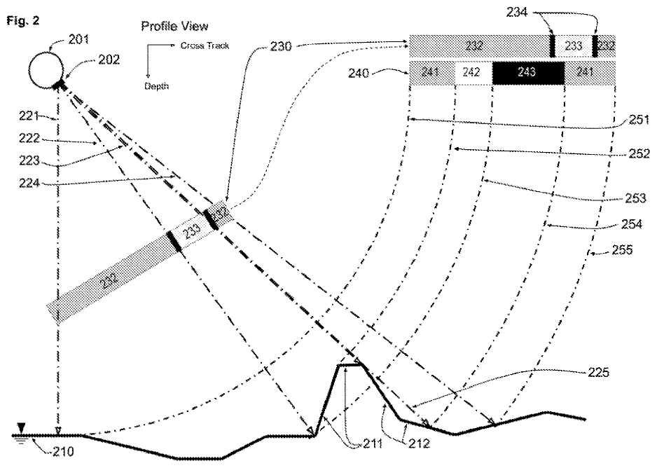

FIG. 3 Sonar Multiview Engine overview

FIG. 4 Sonar Vector and angles definition

FIG. 5 Sonar Vectors from a single ping

FIG. 6 Sonar Vectors from multiple pings, plan view

FIG. 7 Sonar Vectors from multiple pings, projection view

FIG. 8 Example Multiview data processing from multiple track

FIG. 9 Example Sonar Backscatter from multiple tracks

FIG. 10 Mosaiced backscatter processed from multiple tracks

FIG. 11 Example Multiview Engine processing backscatter from multiple tracks

FIG. 12 Example Multiview Analysis

FIG. 13 Example Multiview Display processing

FIG. 14 Example Multiview Display at viewing angle

FIG. 15 Multiview Processing Subsystem Diagram

FIG. 16 Multiview Analysis Subsystem Diagram

FIG. 17 Multiview Single View Classifier Diagram

FIG. 18 Multiview Tensor Classifier Diagram

FIG. 19 Multiview Vector Classifier Diagram

FIG. 20 Multiview Display Diagram

FIG. 21 Example Computing System implementing processes and systems of the disclosure

### DETAILED DESCRIPTION

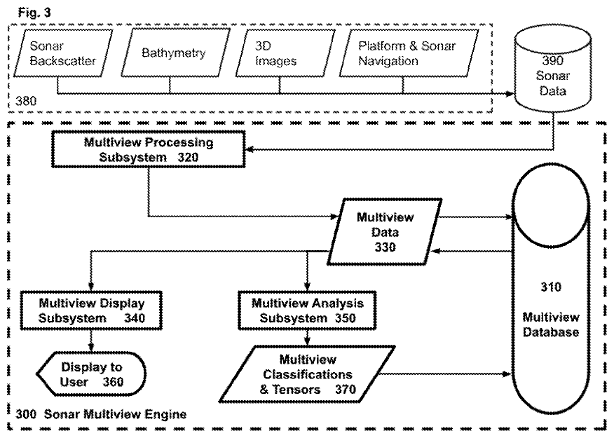

The disclosed examples makes use of the information in the Sonar Vectors to enhance analysis, representation, and interpretation of sonar data. In FIG. 3 sonar data is collected and processed by existing hardware and software 380 which may include SSS, MBES, FLS, SAS, DVL, IMU, INS, LBL, USBL, GPS, FOG, and other sensors or instruments, and data acquisition and processing software that captures and geospatially organizes sonar amplitudes and outputs positioned backscatter amplitudes which may be stored as sonar data 390. The disclosed examples, the Sonar Multiview Engine 300, is a system for sonar data processing with an overview shown in FIG. 3. The Sonar Multiview Engine 300 may use sonar data from multiple sensors 380 and may include three subsystems: a Multiview Processing Subsystem 320, a Multiview Analysis Subsystem 350, and a Multiview Display Subsystem 340. The Sonar Multiview Engine 300 may use a Multiview Database 310 for data storage that may include sonar data, processed sonar data, intermediary forms of data used in processing, and other data. The Sonar Multiview Engine 300 uses data processed by sonar instruments and navigation instruments 380 as input. The Sonar Multiview Engine may be used to produce geophysical and hydrographic seafloor maps, seafloor acoustic reflectance models, seafloor terrain models, and other representations 360 and analyses 370 for interpretation or understanding of the seafloor. The Sonar Multiview Engine may be applied to either new sonar data or existing sonar data 380 that may be stored 390 or streamed directly.

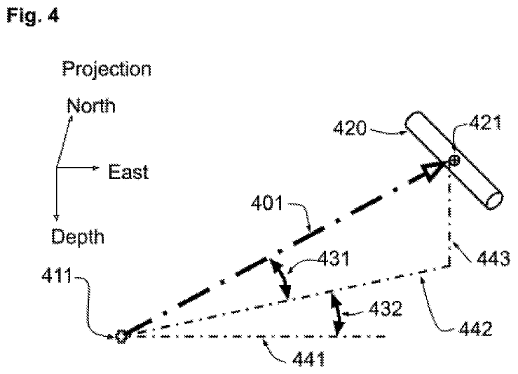

FIGS. 4, 5, 6, 7, 8, 9, 10, and 11 include and introduction to the Sonar Vector and angles used by the examples to enhance sonar analysis and display. All sonar data has a Sonar Vector and angles when collected, though existing sonar processing methods may not store and do not use the information in analysis nor in display. FIGS. 4, 5, 6, 7, 8, 9, 10, 11, 12, 13, and 14 show sonar measurements only on one side of the platform to simplify the presentation; sonar measurements may be made simultaneously on any or all sides of the platform for use in the examples.

An example of the Sonar Vector is shown in FIG. 4 with a platform 420 taking a sonar amplitude measurement. The Sonar Vector 401 has endpoints of the Backscatter Measurement Point 411 on the surface being surveyed, the position is calculated by the sonar and navigation instruments processing, and the Transducer Ping Position 421 calculated by the navigation instrument processing. The Sonar Vector 401 has spherical coordinates of the azimuth angle 432, shown referenced from the East direction 441, and the altitude angle 431 shown from horizontal reference 442 and range from the transducer 421 to the measurement point 411. The Transducer Ping Position's vertical component, called Height Off the Bottom, 443 is shown for reference.

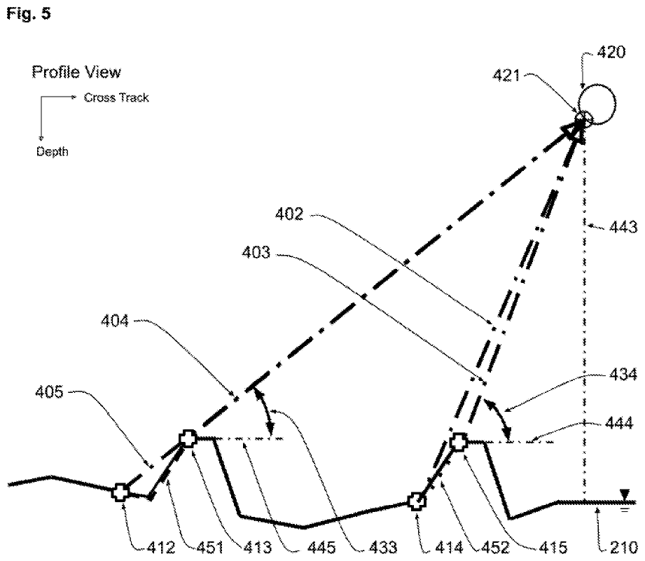

The disclosed examples use the Sonar Vector angles in the analysis and display of the sonar data. In FIG. 5 several Sonar Vectors from a single sonar ping on one side of the platform are shown in profile view in a plane normal to the platform heading. The platform 420 carries a sonar transducer 421 that is at the Transducer Ping Position, and emits the ping and receives the backscatter amplitude. Sonars may use separate transmitters and receivers and the examples may use either's position or a computation from the two positions.

An example of Sonar Vectors improving sonar data interpretation is illustrated in FIG. 5. The seafloor 210 has two identical objects 451 and 452 on it in the ensonified area. The Sonar Vector 403 ensonifices the top back edge of object 452 at a sonar altitude angle 434 with the horizontal reference 444 greater than the slope of the backside of object 452 so the whole backside of object 452 from point 415 to point 414 is ensonified by Sonar Vectors between 402 and 403 and the sonar data of object 452 has no shadow. The second object on the seafloor 451, identical to object 452, is ensonified at top back edge at point 413 by Sonar Vector 404 at an altitude angle 433 with the horizontal reference 445 which is less than the slope of the backside of object 451 so the whole backside of object 451 is in sonar “shadow”, meaning it is not ensonified and the next measurement after Sonar Vector 404 is at point 412 ensonified along Sonar Vector 405, and the sonar data has a shadow, meaning there is no reflected backscatter from the time the reflection from point 404 arrives at the transducer 421 until the reflection from point 405 arrives at the transducer 421. The sonar amplitude data for the identical objects 451 and 452 are very different, 451 having a shadow and 452 without a shadow. The Sonar Vector and sonar altitude angle provide information for analysis to determine the actual appearance of the objects which is used in the multiview analysis and display of the sonar data.

In the example in FIG. 5 the Backscatter Measurement Points 412, 413, 414, and 415 are all collected from the same sonar ping, at the same Transducer Ping Position measured by navigation instruments on platform 420. To compute the Sonar Vectors the system stores the Transducer Ping Position for each Backscatter Measurement Point in some retrievable way. The system may just store the TPP's navigation data with each Backscatter Measurement Point, or store a likely unique subset of the navigation data such as the X and Y coordinate values, or may use a unique TPP identification number (Ping-ID) to efficiently store the TPP with many Backscatter Measurement Points. The system may use the Ping-ID to efficiently store the sonar vectors by storing the Backscatter Measurement Point's XYZ, backscatter amplitude, and Ping-ID in one table and the Transducer Ping Position indexed by Ping-ID in another table thereby reducing the storage requirements from seven or more numbers per sonar amplitude measurement to five numbers per sonar amplitude measurement. In other examples the Sonar Vector may be computed from the Transducer Ping Position for different Backscatter Measurement Points on the same ping to account for platform motions during the time elapsed between receiving the backscatter from the closest Backscatter Measurement Points, e.g. 415, and the furthest Backscatter Measurement Points, e.g. 412; the different Transducer Ping Positions may be stored in the navigation data with different Ping-IDs, or the navigation data may include platform motions that may be used during processing to adjust the Transducer Ping Position for each Backscatter Measurement Point.

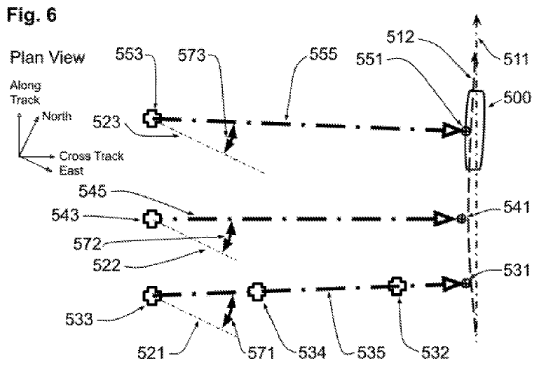

In FIG. 6 an example of the Sonar Vectors'azimuth angle grouping is illustrated in a plan view. The single platform 500 followed track line 511with the navigation data describing the measured path 512 with the measured platform heading deviating slightly from the track line 511 as is common. The navigation data includes the positions measured by navigation instruments, the Transducer Ping Positions, for 531, 541, and 551 each of which are given a unique Ping-ID which is stored with Backscatter Measurement Points 533, 543, and 553 respectively and forms the Sonar Vectors 535, 545, and 555 respectively. The Ping-ID for Transducer Ping Position may be stored with all the Backscatter Measurement Points made with that ping; The Ping-ID for Transducer Ping Position 531 is stored with the Backscatter Measurement Points 533, 534, 532 and is used to lookup the Transducer Ping Position's navigation data to compute those Sonar Vectors.

The sonar beam's physical azimuth angle with respect to the platform and sonar are usually fixed at 90 degrees, resulting in the Sonar Vectors'azimuth angles varying with the platform heading as shown in FIG. 6. In FIG. 6 the first Sonar Vector's 535 actual azimuth angle 571, measured at point 533 to an east reference line 521, is greater than the second Sonar Vector's 545 actual azimuth angle 572, measured at point 543 to an east reference line 522. The third Sonar Vector's 555 actual azimuth angle 573, measured at point 553 measured to an east reference line 523, is the smallest of the three azimuth angles as the platform heading has swung to the east. The system may group all three of these Sonar Vectors 535, 545 and 555 as a single azimuth angle group if their differences are within a tolerance.

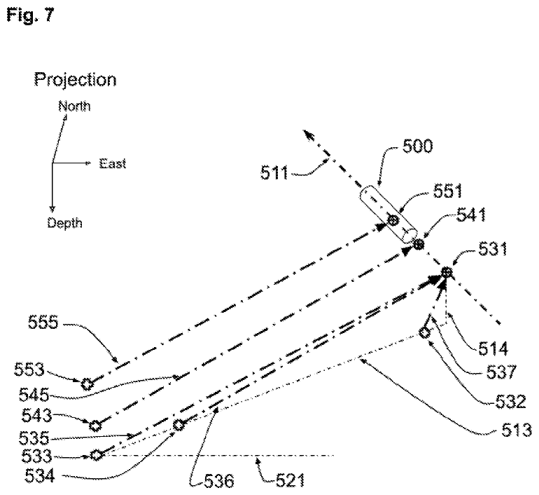

FIG. 7 shows a projection view of the same platform 500 following trackline 511 and sonar data as shown in FIG. 6, with Backscatter Measurement Points 531, 541, and 551, and without showing the navigation path 512 for clarity. For orientation lines are shown for: the east reference line 521; the line of the sonar beam 513 from Transducer Ping Point 531 that includes the Backscatter Measurement Points 533, 534, and 532; and the vertical line 514 under sonar position 531. The Sonar Vectors 535, 536, and 537 taken at Transducer Ping Position 531 may all have the same azimuth angle, as do all Backscatter Measurement Points taken at the same Transducer Ping Position. The Backscatter Measurement Points 533, 534, and 532 and their respective Sonar Vectors 535, 536, and 537 all have different altitude angles (not shown). The Backscatter Measurement Points 533, 543, and 553 and their respective Sonar Vectors 535, 545, and 555 have similar azimuth angles, being from the same track line, and similar altitude angles. The disclosed examples may group the Backscatter Measurement Points azimuth angles and/or altitude angles within an angular tolerance and may process them together; the Backscatter Measurement Points may be from a single pass of a sonar or from multiple passes of different sonars and may be grouped for processing. The analysis may use the actual azimuth angles or an average, median, or other value for the group.

The disclosed examples may efficiently store and compute the Sonar Vectors in a database by giving each Transducer Ping Position a unique identification value, called a Ping-ID, which may be used as an index in the database of sonar, navigation and other tables. The Ping-ID may be stored with each Backscatter Measurement Point and may be an index for the Transducer Ping Position table. The Backscatter Measurement Point and the Transducer Ping Position are the endpoints of the Sonar Vector for each sonar measurement. For each Ping-ID there may be any number of Backscatter Measurement Points and Sonar Vectors; typically for SSS there may be over 10,000 Backscatter Measurement Points for each Ping-ID. By using a unique identification number for the Transducer Ping Position with each sonar measurement in the database the system efficiently stores the Transducer Ping Position with the one Ping-ID number instead of the platforms position and velocities which may have twelve or more numbers including X, Y, Z, Yaw, Roll, Pitch, Vx, Vy, Vz, wYaw, wRoll, wPitch. The system also is efficient in retrieval of the Transducer Ping Position using the Ping-ID as a database index. An example may make a unique Ping-ID by concatenating a Platform identification number, a Sonar identification number, the date, and the time. Another example may use a list of Ping-IDs with assigned blocks of numbers for surveys. Another example may use unique identification by Sonar Vector direction, azimuth angle, altitude angle, or a process using the Sonar Vector information.

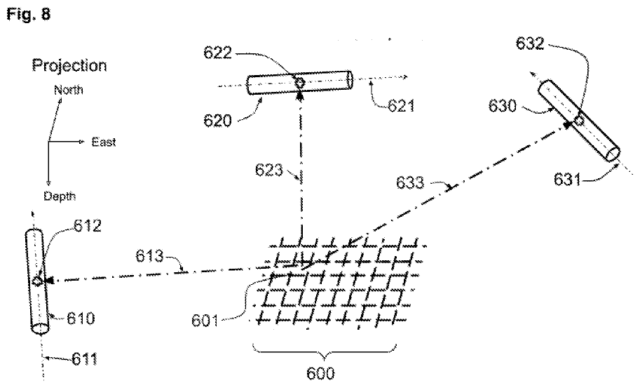

The disclosed system applies the Sonar Vectors information in the analysis and display of sonar data. In FIGS. 8, 9, 10, 11, 12, 13, and 14 a simplified example is presented. This example uses only three sonars on platforms following different track lines for clarity; the examples may be applied to any number of track lines and sonars. This example uses only one Backscatter Measurement Point from each sonar, per grid box for clarity, the examples may use any number of Backscatter Measurement Points from each sonar per grid box. This example uses SSS and MBES sonar for clarity, the examples may use any type of sonar that provides data with amplitude and positions of both the Backscatter Measurement Point and the Transducer Ping Position. This example uses a grid of only 8 by 5 boxes, the examples may use grids of any size with any number of points in the grid boxes. The grid in this example is shown with square boxes, aligned to the north and east for clarity, the examples may use a grid of any shape boxes at any alignment. The feature in the example used is aligned with and fully crossed the grid, in the example features may be measured and processed at any alignment and any size.

FIG. 8 shows a projection view of a survey grid 600 with three independent Sonar Vectors 613, 623, and 633 for three Backscatter Measurement Points in a grid box 601 with the backscatter measurements having been taken one each from platforms 610, 620, 630, at Transducer Ping Positions 612, 622, and 632. In this example, each of the boxes in the survey grid 600 have three Backscatter Measurement Points with associated Transducer Ping Positions shown as the Sonar Vectors 613, 623, and 633, one from each of the platforms as they transverse their respective track lines 611, 621, and 631. Each platform's sonar and navigation data provides both the platform position, 612, 622, and 632, and the position of each Backscatter Measurement Points on the seafloor in the sonar and navigation data. Each box in the grid 600 contains one data point from each of the sonars 612, 622, and 632 with backscatter amplitude, Backscatter Measurement Point position, and Transducer Ping Position for each data point.

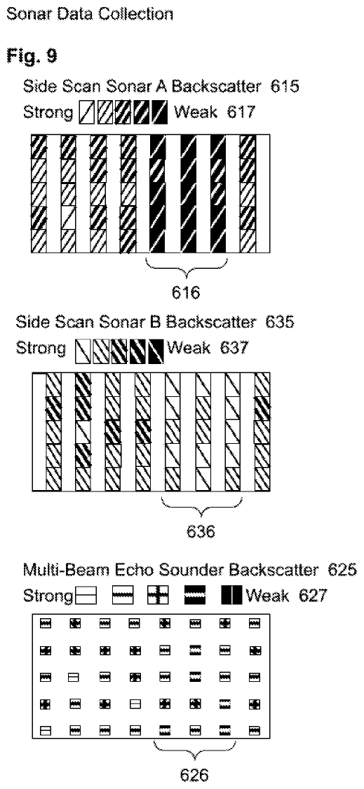

FIG. 9 shows sonar backscatter amplitude measurements in the grid 600 from each of the three platforms separately: from Platform 610 using a side scan sonar SSS-A 615, from platform 620 using a MBES 625, and from platform 630 using a side scan sonar SSS-B 635. In this example, each sonar measurement of backscatter is represented on a five step scale, 617, 627, and 637, for clarity, from “strong” reflection to “weak” reflection illustrated with “strong” reflection being mostly white, “weak” reflections being mostly black, and the middle steps being progressively more black as they get weaker. The disclosure may use backscatter amplitude scales of any resolution. Each platform's sonar measurement representation in FIG. 9 is unique to allow distinguishing them when combined in processing steps that follow. The backscatter representations are spaced out in columns for clarity. The SSS-A backscatter 615 shows a strong vertical shadow three columns wide 616, which on SSS-B backscatter 635 shows as a strong reflection 636, and on the MBES backscatter 625 is indistinct 626. To one skilled in the art of sonar interpretation the combination of the shadow 616 and strong reflection 636 would indicate a feature with a vertical face higher to the west and lower to the east.

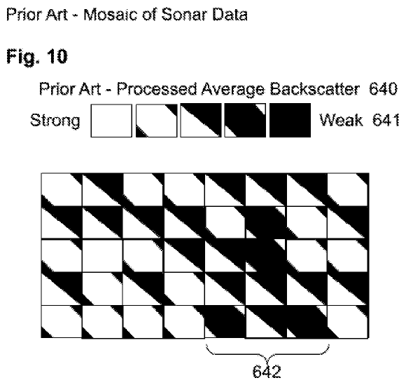

FIG. 10 shows results of using prior art processing to make a mosaic. Existing methods mosaic the sonar measurements by choosing or combining the separate measurements without considering the Sonar Vector. In the example the three backscatter measurements in each grid box of FIG. 9 615, 625 and 635 have been averaged using the five-step strong-to-weak scale 641 and shown as in the grid 640. The averaging reduces the data's dynamic range and makes the feature 642 harder to identify.

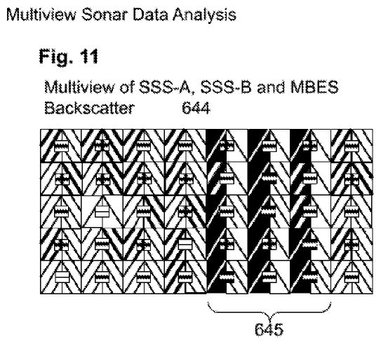

FIG. 11 shows a visualization of an embodiment of the processing of the disclosure. An example embodiment represents a combination of the sonar measurements 644 in the grid and grouped by azimuth angle, which makes the feature 645 more distinct due to the contrast of the adjacent grid boxes of weak reflections from SSS-A 616 next to strong reflections from SSS-B 626. This added information, the contrast between sonar measurements from different Sonar Vectors is enabled by the storing and tracking of the Sonar Vector for each Sonar Measurement Point.

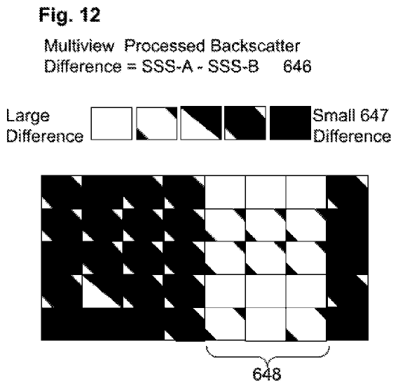

FIG. 12 shows an example embodiment of the processing to enhance feature detection. This embodiment of an analysis calculates the difference between backscatter measurements from different Sonar Vectors here calculated as the absolute value of the difference for each grid box between amplitudes from sonar 612 and sonar 632:

$$Difference = \vert SSSA - SSSB \vert$$

The disclosure may use any number of sonar measurements and any algorithm in processing to enhance analysis. In FIG. 12 the feature 648 stands out in grid 646 with very large differences on the scale 647.

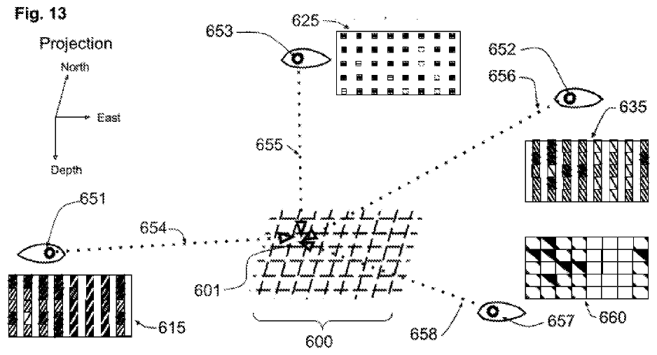

An example embodiment of the display function is shown in FIG. 13 with data views 615, 625, and 635 from View Vectors 654, 655, and 656 corresponding to each of the Sonar Vectors in FIGS. 8, 613, 623, and 633 and an example processed display from an arbitrary View Vector 658 where View Vector is the vector direction of the users display of the survey area. Embodiments of the disclosure may process displays from any number of View Vectors and any azimuth or altitude angles. When the user's View Vector is within a tolerance of a Sonar Vector, the display may be the amplitudes from that Sonar Vector as shown in displays 615, 625, and 635. When the user's View Vector is outside the tolerance of a Sonar Vector, the disclosure may compute the display based on multiple Sonar Vectors, computer models of the seafloor, or other algorithms to display the sonar data.

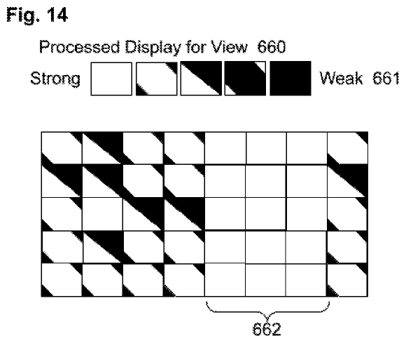

In FIG. 14 an example embodiment of the display at Viewing Vector outside the tolerance of any Sonar Vector is shown. The example display 660 shows a grids of pixels from View Vector 658 computed as a combination of amplitudes from Sonar Vectors 613, 623, and 633 proportional to the View Vectors alignment with each Sonar Vector and amplified when Sonar Vectors nearly opposite the View Vector show sonar shadow, and using a 5 step scale 661. The feature 662 stands out very clearly and on a scale with higher resolution would retain the more detailed information about the object.

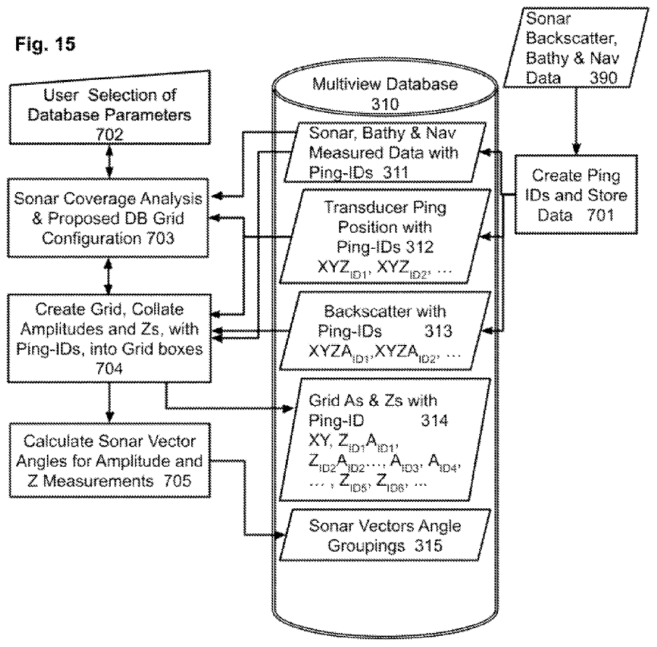

An example processing method shown in FIG. 3 includes three subsystems: a Multiview Processing Subsystem 320, a Multiview Analysis Subsystem 350, and a Multiview Display Subsystem 340 which are detailed in FIGS. 15, 16, 17, 18, 19, and 20.

The example first sub-system is the Multiview Data Processing 320, shown in FIG. 15 that populates tables in the Multiview Database 310. In FIG. 15 the sonar backscatter, bathymetry, and navigation data 390, relate the Backscatter Measurement Points to the Transducer Ping Positions, such as track line data from seafloor surveys are stored in the Measured Data table 311. Sonar data that has already been mosaiced or otherwise lost the relationship between Backscatter Measurement Point and Transducer Ping Position may be additionally processed to calculate or estimate the relationship that can then be processed to Create Ping-IDs 701. The sonar backscatter, bathymetry, and navigation data 390 is also processed to add the unique Ping-ID numbers to each measurement that tie each Sonar Ping Measurement to the specific navigation data for the ping 701, then the Transducer Ping Positions 312 and Backscatter with Ping-IDs 313 are stored in the database for efficient use in multiview analysis 350 and display 340 sub-systems. The user interacts with coverage analysis 703 to select the parameters for the configuration of the data 702 including grid spacing, if the depth is to be stored by each reading, or as a processed single number and what process is to be used, and other data storage and processing options. The grid parameters are used in the gridding process 704 to make the database table Grid As & Zs with Ping-ID 314 which preferably has multiple amplitude and depth measurements, with their Ping-IDs/Sonar Vectors, in each grid box. Commonly the Z, depth, measurement grid size is several times larger than grid size of the backscatter amplitude measurements and have fewer overlapping measurements from different line/directions; the grid may be populated with Z, depth, data as nearest measurement, best fit surface, interpolated, or other mechanism of computing the Z, depth at each grid box. The Sonar Vectors angle groups are found and pointers stored 705 in the database Sonar Vectors Angle Groupings table 315 with the grouping parameters selected in the Configuration of Data 702 that may include groupings by Altitude angle, Azimuth angle, or both. The Sonar Vector may be represented in various ways, in one example the Sonar Vector may be represented by its cartesian coordinates delta X, delta Y, and delta Z; in another example the Sonar Vector may be represented by its spherical coordinates Azimuth, Altitude, and Range; in another example the Sonar Vector may be represented by only the spherical angles Azimuth and Altitude omitting range.

In some examples the Multiview Processing Subsystem may improve the accuracy of the navigation of the platform, and sensor, or the location of the Sonar Measurement Position by using post processing methods. The post processing methods may include simultaneous location and mapping (SLAM), object detection and best fit colocation by adjustment of tracks, seabed material edge detection and best fit colocation by minimum adjustment of tracks, or other location processing.

The Multiview Sonar Data Processing 320 processes the measurement data to make a grid with each box in the grid having sonar amplitude measurements, preferably multiple measurements from multiple and opposing azimuth directions, e.g. four Backscatter Measurement Points with azimuth angles at compass points of 0, 90, 180, and 270 degrees.

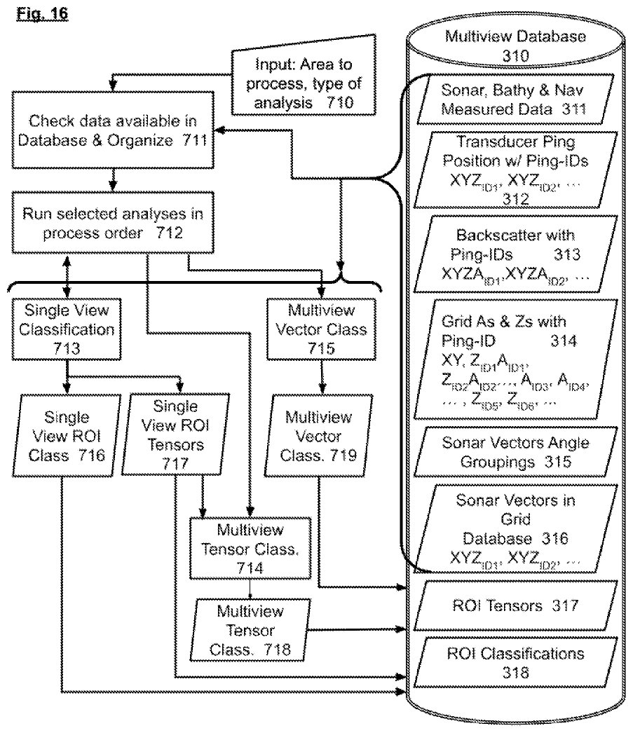

The Multiview Analysis Subsystem 350 overview, shown in FIG. 16, may use any of several classification mechanisms to either identify types of areas, types of objects, delineations between types, or other identifiable features on the seafloor or in the ocean. Example classification mechanisms include: Single Vector Classification 713, Multiview Tensor Classification 714, Multiview Vector Classification 715, or other mechanisms of classification, which are also shown in following figures. The user inputs 710 of the parameters of the area to be processed, types of analysis to be performed, and other analysis configuration parameters. The Check Database and Organize routine 711 finds appropriate data for the analysis in the Multiview Database 310 and organizes for processing by the selected analyses. The Multiview Database 310 is used by many routines in the system and includes storage, tables, and pointer to other data storage for sonar data both measured and corrected/processed 311 312, and multiview sonar data 313-318. The Run Selected Analyses 712 is a control routine that calls the analysis routines with the parameters and data pointers in the required order. The analysis routines all use sonar data from the Multiview Database 310 and may include Single View Classification 713, Multiview Tensor Classification 714, Multiview Vector Classification 715, or other classification processes. The term “Tensor” here refers to the data format used in neural networks and the tensor array may have any number of dimensions. The Single View Classification 713, Multiview Tensor Classification 714, and Multiview Vector Classification 715 routines output Regions Of Interest (ROI) 716, 718, and 719. The Single View Classification also outputs Single View ROI Tensors 717 that are stored in the Multiview Database 310 for use by the Multiview Tensor Classification 714 routine. For example referencing FIG. 8 the area 600 has been surveyed from Sonar Vector angles 613, 623, and 633. The differences in the data due to Sonar Vector angle is shown in FIG. 13, data representations 615, 625, and 635. Processing this data using the Multiview Tensor Classification mechanism includes the following steps:
1. The “Check data available in Database & Organize” mechanism 711 will identify the data in the Multiview Database and return an error if the data is unavailable
2. The “Check data available in Database & Organize” mechanism 711 will identify all available Sonar Vector angle groups for the area, three for area 600, and group the backscatter data by the similar angles, organized by 615, 625, and 635 for area 600, to separately process each angle group using the Single View Classification mechanism 713.
3. The “Run selected analyses in process order” mechanism 712 will run the Single View Classification mechanism 713 once for each angle group.
4. Each run of the Single View Classification mechanism 713 will process the data from a single angle group by loading area data from the Multiview Database tables 311, 312, 313, 314, 315, and 316 as needed to generate the Single View ROI Tensors 717, which will be stored in the ROI Tensors table 317. The Single View Classification mechanism 713 may also generate Single View Classifications that may be stored in the ROI Classifications table 318.
5. The “Run selected analyses in process order” mechanism 712 will repeat running the Single View Classification mechanism 713 until all the angle groups are processed to Single View ROI Tensors 717; three times for area 600.
6. The “Run selected analyses in process order” 712 will run the Multiview Tensor Classification 714 with inputs of the ROI Tensors from each of the three Single View Classification runs and any additional data needed from the Multiview Database 310.
7. The Multiview Tensor Classification 714 will load and process the multiple tensors generating a set of Multiview Tensor Classification 718 that will be stored in the ROI Tensors 317 and ROI Classifications 318.

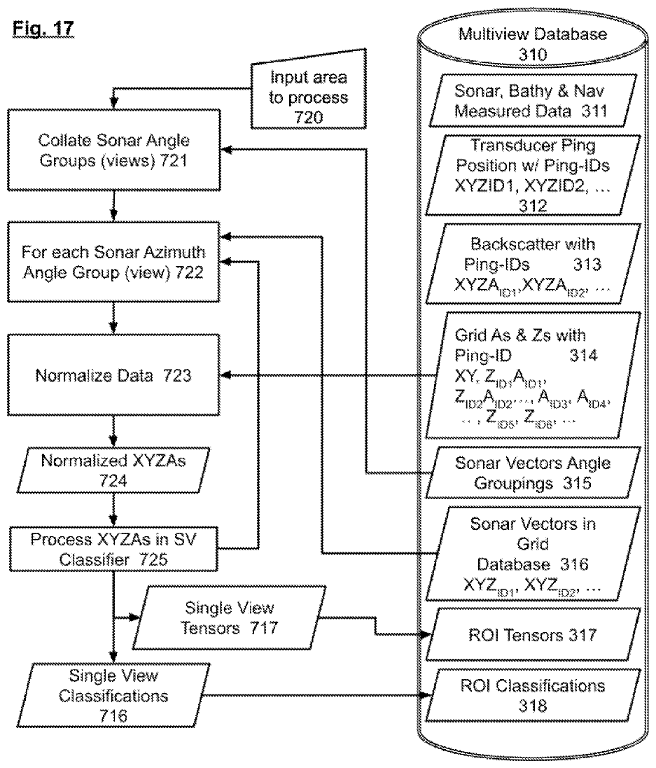

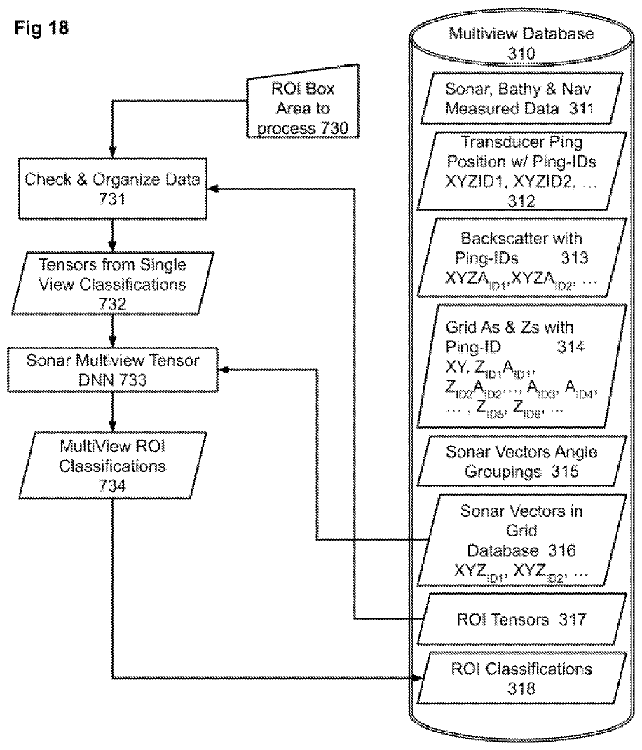

In FIG. 17 the process of Single View Classifier sub-system 713 of the Multiview Analysis Subsystems is shown. The Single View Classifier may be used as a stand-alone classifier, or as a first step in the analysis system, and produces both classifications and tensors that are stored in the Multiview Database and the classifications available for display to the user. The Single View Classifier may use any neural network classification method that generates tensors. The tensors from each single view from the different Angle Groups are used in the Multiview Tensor Classifier 733 in FIG. 18. The single view classifier may loop to analyze and classify an area from multiple angle groups, such as all, the azimuth angle groups available in the Multiview Database 310. The survey area to process is input 720 from either user input or from the Multiview Analysis Subsystem's Run Selected Analyses process 712. The first process Collate Sonar Angle Groups 721 checks and organizes the data from the Multiview Database for the area in the Sonar Vectors Angle Groupings table 315. The identified data is passed to the classification loop 722 that calls the Normalize Data routine 723 to prepare the data for the neural network or other classification routine, then calls the classification routine 725 passing the Normalized data 724. The Classification routine produces Single View Tensors 717 and SV Classifications 716 that are stored in respective ROI tables 317 and 318 in the MVDB 310. The use of Angle Group improves classification by combining data from separate track lines where appropriate and separating views of an object that may look different due to significantly different altitude or azimuth angle.

In FIG. 18 the process of Multiview Tensor Classifier sub-system 714 is shown. The Multiview Tensor Classifier uses the Tensors produced by the Single View Classifier 713 in its classification. The survey area to process 730 is input from either the user or from the Multiview Analysis Subsystem's Run Selected Analyses process 712. The first process Checks and Organizes 731 the data from the Multiview Database for the area in the ROI Tensors table 317 or directly from the Single View Classification 713. The organized Tensors 732 are processed by the Sonar Multiview Tensor classifier 733 which may use a deep neural network or other classification mechanism to produce the Multiview ROI classifications 734 which are stored in the multiview Database ROI Classification table 318. The use of multiple single view tensors in a secondary classification process improves classification confidence and accuracy.

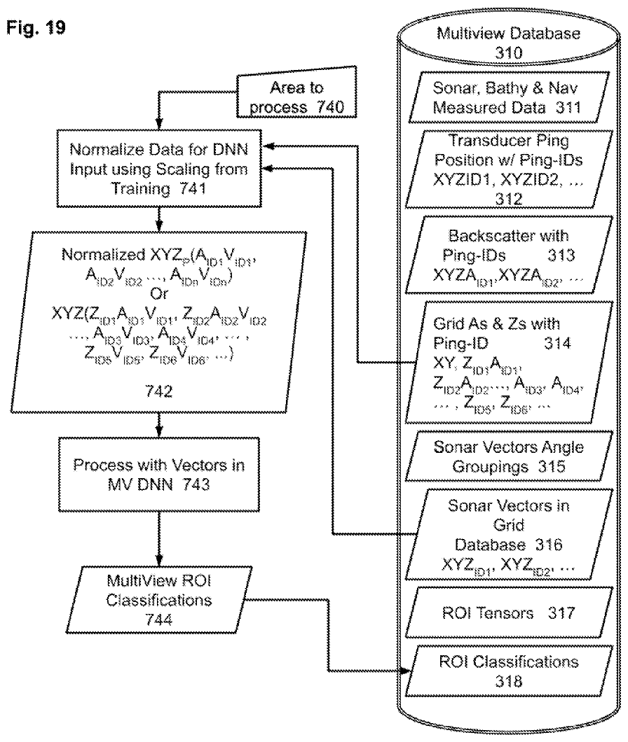

FIG. 19 shows the process of the Multiview Vector Classifier sub-system 715 that uses the Sonar Vectors with the amplitude and/or depth measurements in a grid. The area to process is input either from the user or from the Multiview Analysis Subsystem's Run Selected Analyses process 712. The Multiview Vector Classifier 715 uses data from the Grid As & Zs table 314 and the Sonar Vectors table 316 in the Multiview Database 310 as the data sources, then reorganizes the data into the format used by the Vector Classification process 743 and Normalizes the Data 741. The Normalized Data 742 format may include separate depth measurements with the associated Sonar Vectors, or a single depth value processed from the measurements and Sonar Vectors. The normalization may use the same normalization process used in the development or training of the classification mechanism. The Normalized XYZAV data 742 is sent to the Vector Classification process 743 which may be a variety or combination of classification mechanism including neural network, machine vision, or others. The output of the Vector Classification process 743 are the Regions Of Interest Classifications 744 which are stored in the Multiview Database's ROI Classification Table 318.

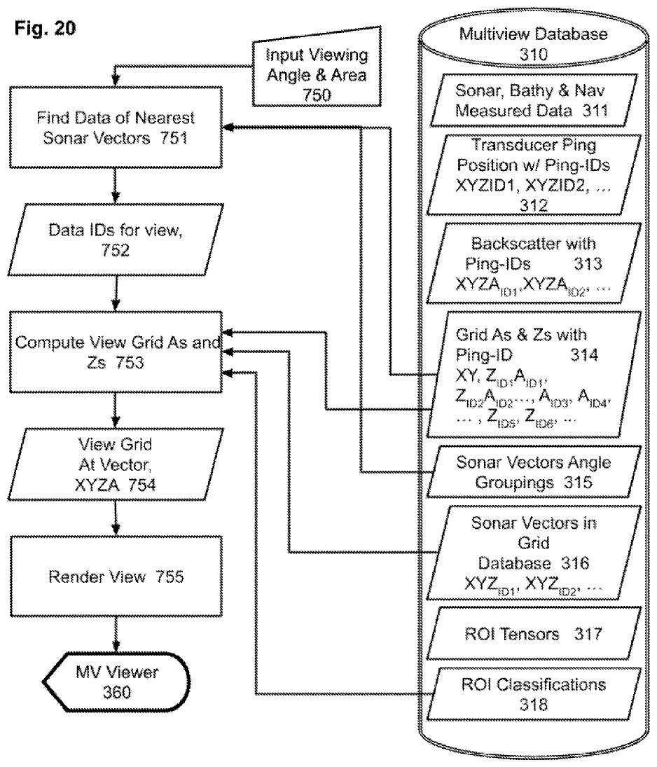

In FIG. 20 the Multiview Display subsystem process 340 that works with the multiview viewer 360 to display data to the user is shown. The Multiview Display subsystem displays the data dependent on angle of view using the data's Sonar Vectors to improve manual analysis. The Input Viewing Area and Angle 750 to be displayed may come from the user via any type of input. The Find Data process 751 uses the Sonar Vectors table 315 and/or the Grid As & Zs 314 to identify the useful available data. The Compute Area Grid 753 uses the Data IDs 752 to get the Grid As & Zs 314 and the Sonar Vectors 316 in a mechanism to produce the View Grid at Vector 754 to be displayed. The mechanism to compute the View Grid 754 may be interpolation between the measure amplitudes relative to their Sonar Vector's relation to the View Vector, or neural network image interpolation, or other computer vision processing mechanism. The View Grid at Vector 754 data is three dimensional, XYZ, and the computed amplitude for the viewing angles and may be formatted in a standard geospatial format, a third party format, or a custom format. The View Grid 745 is used by the Render View routine 755 to render the actual display; the Render View mechanism may be a custom program, or a third party rendering program. The user may view the display on a screen or printed output as the MV Viewer 360.

The Multiview Display subsystem may enhance the users analysis by adjusting the display with processes using the Sonar Vectors, the Sonar Vectors azimuth or altitude angles, or other mechanism. The Multiview Display may mix representations of the sonar data from any number of track lines and may be adjustable by the user.

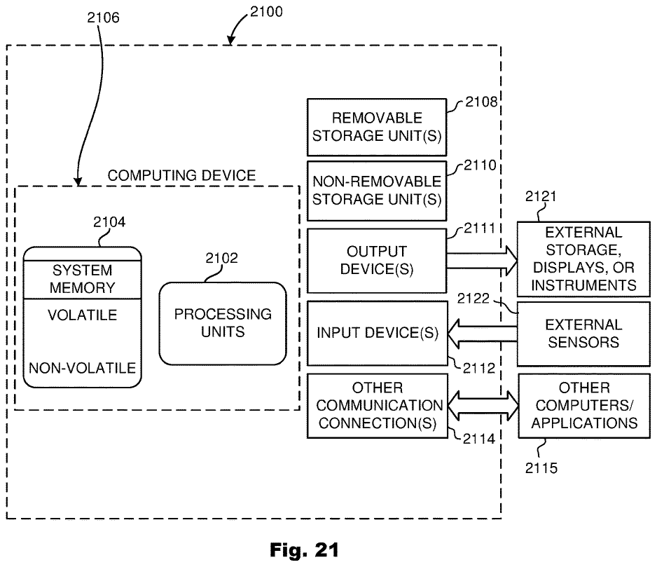

FIG. 21 illustrates an exemplary computer system that can be employed in an operating environment and used to host or run a computer application included on one or more computer readable storage mediums storing computer executable instructions for controlling the computer system, such as a computing device, to perform a process. The computer system can be implemented to apply Sonar Multiview Engine 300, or a subsystem such as Multiview Processing Subsystem 320, Multiview Analysis Subsystem 350, or Multiview Display Subsystem 340 as well as Multiview database 310. In another example, the processes applied by the Sonar Multiview Engine 300, or a subsystem such as Multiview Processing Subsystem 320, Multiview Analysis Subsystem 350, or Multiview Display Subsystem 340 as well as Multiview database 310 can be implemented to run on computer system as application on one or more computer readable storage mediums storing computer executable instructions for controlling the computer system, such as a computing device, to perform the processes.

The exemplary computer system includes a computing device, such as computing device 2100. The computing device 2100 can take one or more of several forms. Such forms include an embedded computer, a cloud based virtual computing environment(s), distributed computing environments, a tablet, a personal computer, a workstation, a server, a handheld device, a consumer electronic device (such as a video game console or a digital video recorder), or other, and can be a stand-alone device or configured as part of a computer network.

In a basic hardware configuration, computing device 2100 typically includes a processor system having one or more processing units, i.e., processors 2102, and memory 2104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 2102. The memory 2104 may be arranged in a hierarchy and may include one or more levels of cache. Depending on the configuration and type of computing device, memory 2104 may be volatile (such as random access memory (RAM)), non-volatile (such as read only memory (ROM), flash memory, etc.), or some combination of the two.

Computing device 2100 can also have additional features or functionality. For example, computing device 2100 may also include additional storage. Such storage may be removable or non-removable and can include magnetic or optical disks, solid-state memory, or flash storage devices such as removable storage 2108 and non-removable storage 2110. Computer storage media includes volatile and nonvolatile, removable and non-removable media implemented in any suitable method or technology for storage of information such as computer readable instructions, data structures, program modules or other data. Memory 2104, removable storage 2108 and non-removable storage 2110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 2100. Accordingly, a propagating signal by itself does not qualify as storage media. Any such computer storage media may be part of computing device 2100.

Computing device 2100 often includes one or more input and/or output connections, such as USB connections, display ports, proprietary connections, and others to connect to various devices to provide inputs and outputs to the computing device. Input devices 2112 may include devices such as keyboard, pointing device (e.g., mouse, track pad), stylus, voice input device, touch input device (e.g., touchscreen), or other. The input devices may include connections to external sensors 2122 that may send data to the computing device 2100. Output devices 2111 may include devices such as a display, speakers, printer, or the like. The output devices may include external storage, displays, or instruments 2121 that receive data from the computing device 2100.

Computing device 2100 often includes one or more communication connections 2114 that allow computing device 2100 to communicate with other computers/applications 2115. Example communication connections can include an Ethernet interface, a wireless interface, a bus interface, a storage area network interface, and a proprietary interface. The communication connections can be used to couple the computing device 2100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the internet, or other network.

In one example, one or more of computing device 2100 can be configured as a client device for a user in the network. The client device can be configured to establish a remote connection with a server on a network in a computing environment. The client device can be configured to run applications or software such as operating systems, web browsers, cloud access agents, terminal emulators, or utilities.

In one example, one or more of computing devices 2100 can be configured as a server or as servers in a datacenter to provide distributed computing services such as cloud computing services. A data center can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 2100 can be configured as servers, either as stand-alone devices or individual blades in a rack of one or more other server devices. One or more host processors, such as processors 2102, as well as other components including memory 2104 and storage 2110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

Cloud-computing providers generally offer services for the cloud-computing environment as a service model provided as one or more of an infrastructure as a service, platform as a service, and other services including software as a service. Cloud-computing providers can provide services via a subscription to tenants or consumers. For example, software as a service providers offer software applications as a subscription service that are generally accessible from web browsers or other thin-client interfaces, and consumers do not load the applications on the local computing devices. Infrastructure as a service providers offer consumers the capability to provision processing, storage, networks, and other fundamental computing resources where the consumer is able to deploy and run software, which can include operating systems and applications. The consumer generally does not manage the underlying cloud infrastructure, but generally retains control over the computing platform and applications that run on the platform. Platform as a service providers offer the capability for a consumer to deploy onto the cloud infrastructure consumer-created or acquired applications created using programming languages, libraries, services, and tools supported by the provider. In some examples, the consumer does not manage or control the underlying cloud infrastructure including network, servers, operating systems, or storage, but has control over the deployed applications and possibly configuration settings for the application-hosting environment. In other examples, the provider can offer a combination of infrastructure and platform services to allow a consumer to manage or control the deployed applications as well as the underlying cloud infrastructure. Platform as a service providers can include infrastructure, such as servers, storage, and networking, and also middleware, development tools, business intelligence services, database management services, and more, and can be configured to support the features of the application lifecycle including one or more of building, testing, deploying, managing, and updating.

### Example Terminology

Amplitude: measured acoustic energy as in measurement of Backscatter; may be raw, corrected, or adjusted;
Backscatter: the acoustic reflection of a sonar ping off the seafloor
Backscatter Measurement Point: the seafloor area of a single sonar measurement with XY or XYZ position in the survey coordinate system with backscatter amplitude and/or depth measurements.
Multiview Analysis Subsystem: the part of the multiview system that takes data from the Multiview Database and processes it to identify object, targets or regions of interest
Multiview Database: the system's database for efficiently storing and retrieving sonar data and Sonar Vector information.
Multiview Display Subsystem: the part of the multiview system that takes data from the Multiview Database and displays it to a user using Sonar Vectors
Multiview Processing Subsystem: the part of the multiview system that takes sonar and navigation data and processes it for storage in, and efficient retrieval from the Multiview Database
Multiview Tensor Classifier Subsystem: a system of classifying regions of interest in sonar data using the tensor output from more than one single view classification analysis in the classification process.
Multiview Vector Classifier Subsystem: a system of classifying regions of interest in sonar data using the Sonar Vector in the classification process.
Ping-ID: unique identifier for every sonar ping that the system associates with all measurements in the Multiview Database including backscatter, depth, and navigation.
Single View Classification: a system of classification that uses data from a single sonar survey track line providing a view from only one side of the survey area.
Sonar Angles: Azimuth and Altitude angles in the survey's coordinate system of a Sonar Vector
Sonar Arm: 3D offset from a sonar's transducer center to the Platform's position center (usually the INS).
Sonar Multiview Engine: the name of the disclosed system for processing, analysis and display of sonar data.
Sonar Range: distance of the Sonar Vector
Sonar Vector: directional vector from the Backscatter Measurement Point to the Transducer Ping Position
Transducer Ping Position: the position in the survey coordinate system of the sonar transducer on the platform when a ping was sent and received. May be just XYZ or may include all navigation measurements including pitch, roll, yaw, linear and angular velocities and linear and angular accelerations.
View Vector: vector from the pixel to be displayed to the user's selected point-of-view [User input] or from the center of the displayed area to the user's selected point-of-view.
View Angles: Azimuth and Altitude of the View Vector

1. A multiview sonar processing system as substantially shown and described herein.

2. A system as claimed in claim 1, further comprising: a multiview sonar analysis subsystem as substantially shown and described herein.

3. A system as claimed in claim 1, further comprising: a multiview sonar display subsystem as substantially shown and described herein.

4. A system as claimed in claim 1. further comprising: a multiview processing system with a method of storing sonar data for efficient retrieval as substantially shown and described herein.

5. A system as claimed in claim 1, further comprising: a multiview sonar processing system in combination with a multiview sonar analysis subsystem as substantially shown and described herein.

6. A system as claimed in claim 1. further comprising: a multiview sonar processing system in combination with a multiview sonar display subsystem as substantially shown and described herein.

7. A system as claimed in claim 1, further comprising: a multiview sonar display subsystem in combination with a multiview sonar analysis subsystem as substantially shown and described herein.

8. A method of generating multiview data from sonar data as substantially shown and described herein.

9. A method as claimed in claim 8, further comprising: a method of generating multiview classifications, tensors, or both from multiview data as substantially shown and described herein.

10. A method as claimed in claim 8, further comprising: a method of using a multiview display subsystem to display multiview data as substantially shown and described herein.

11. A system as claimed in claim 14, further comprising: a computer readable storage device to store computer executable instructions to control a processor to generate multiview data from sonar data as substantially shown and described herein.

12. A system as claimed in claim 15, further comprising: a computer readable storage device to store computer executable instructions to control a processor to generate multiview classifications, tensors, or both from multiview data as substantially shown and described herein.

13. A system as claimed in claim 16, further comprising: a computer readable storage device to store computer executable instructions to control a processor to apply a multiview display subsystem to display multiview data as substantially shown and described herein.

14. A system, comprising:
a memory device to store a set of instructions; and
a processor to execute the set of instructions to: generate multiview data from sonar data as substantially shown and described herein.

15. A system as claimed in claim 14, further comprising:
a memory device to store a set of instructions; and
a processor to execute the set of instructions to: generate multiview classifications, tensors, or both from multiview data as substantially shown and described herein.

16. A system as claimed in claim 14, further comprising:
a memory device to store a set of instructions; and
a processor to execute the set of instructions to: apply a multiview display subsystem to display multiview data as substantially shown and described herein.
